(19) United States
(12) Patent Application Publication
(10) Pub. No.: US 2007/0256012 A1
(43) Pub. Date: Nov. 1, 2007

(54) User interface for browsing content, method of providing the user interface, and content browsing apparatus

(75) Inventors: So-hee Jang, Gangnam-gu (KR); Yong-sung Kim, Suwon-si (KR); Tae-ung Jung, Suwon-si (KR); Dong-hyun Roh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/650,939

(22) Filed: Jan. 9, 2007

(30) Foreign Application Priority Data
Feb. 6, 2006 (KR) 10-2006-0011216

(51) Int. Cl. G06F 3/00

(52) U.S. Cl. 715/700

(57) ABSTRACT

A user interface for browsing content, a method of providing a user interface, and a content-browsing apparatus are provided. The method includes dividing a plurality of content into a number of content groups according to a clustering condition, and providing a user interface including a cell field that has a group cell having a subcell corresponding to content included in a content group determined by the clustering condition, the group cell corresponding to the content group, a selector that indicates the subcell, and preview information for the content corresponding to the subcell indicated by the selector.

### CROSS-REFERENCE TO RELATED APPLICATION

This application is based on and claims priority from Korean Patent Application No. 10-2006-0011216 field on Feb. 6, 2006 in the Korean Intellectual Property Office, the disclosure of which is incorporated herein in its entirety by reference.

### BACKGROUND OF THE INVENTION

1. Field of the Invention

Apparatuses and methods consistent with the present invention relate to a user interface, and more particularly, to a user interface for browsing content, a method of providing the user interface, and a content browsing apparatus.

2. Description of the Related Art

High-capacity digital storage devices, such as hard disk drives and flash memories, and data compression technologies, a multimedia content storage function have been increased. For example, a portable Moving Picture Experts Group—1 Audio Layer 3 (MP3) player or a portable multimedia player (PMP) can store more than ten thousand songs. A digital video recorder (DVR) can store more than ten thousand pictures and hours of moving pictures.

Since digital devices can share multimedia content with each other by being connected via a network, the amount of multimedia content accessible by one digital device is increasing.

Korean Unexamined Patent No. 10-2005-66790: “Apparatus and Method for Searching and Browsing Multimedia Content” discloses a method of searching and browsing multimedia content, which supports efficient searching and browsing of multimedia content and metadata by displaying a searching/browsing result in an interactive type. Technologies for enabling a user to search and browse desired content easily have been developed, but more various content-browsing technologies are required.

### SUMMARY OF THE INVENTION

The present invention provides a user interface for browsing content, a method of providing a user interface, and a content-browsing apparatus which enable an easy and efficient content search.

According to an aspect of the present invention, there is provided a user interface for browsing content, the user interface including a cell field that has a group of cell having a subcell corresponding to content included in a content group determined by a clustering condition, the group cell corresponding to the content group, a selector that indicates the subcell, and preview information for the content corresponding to the subcell selected by the selector.

According to another aspect of the present invention, there is provided a user interface providing method including dividing a plurality of content into a number of content groups according to a clustering condition, and providing a user interface that includes a cell field that has a group cell having a subcell corresponding to content included in a content group determined by the clustering condition, the group cell corresponding to the content group, a selector that indicates the subcell, and preview information for the content corresponding to the subcell selected by the selector.

According to still another aspect of the present invention, there is provided a content-browsing apparatus including a clustering unit that divides a plurality of content into a number of content groups according to a clustering condition, and a display unit that displays a user interface which includes a cell field that has a group cell having a subcell corresponding to content included in a content group determined by the clustering condition, the group cell corresponding to the content group, a selector that indicates the subcell, and preview information for the content corresponding to the subcell indicated by the selector.

### BRIEF DESCRIPTION OF THE DRAWINGS

The above and other aspects of the present invention will become apparent by describing in detail exemplary embodiments thereof with reference to the attached drawings, in which:

FIG. 1 is a block diagram illustrating a content-browsing apparatus according to an exemplary embodiment of the present invention;

FIGS. 2A through 2D illustrate a configuration of a cell field and a group of cells according to an exemplary embodiment of the present invention;

FIGS. 3A and 3D illustrate a user interface according to an exemplary embodiment of the present invention;

FIG. 4 is a flowchart illustrating a method of providing a user interface according to an exemplary embodiment of the present invention;

FIG. 5 is a flow chart illustrating a moving process of a selector according to an exemplary embodiment of the present invention;

FIG. 6 is a flow chart illustrating a process of controlling a length of a group cell and a width of a subcell according to an exemplary embodiment of the present invention;

FIG. 7 is a flowchart illustrating a process of controlling a length of a group cell and a width of a subcell according to another exemplary embodiment of the present invention;

FIGS. 8A and 8B illustrate a process of increasing a length of a cell field according to another exemplary embodiment of the present invention;

FIG. 9 is a flowchart illustrating a process of increasing a length of a cell field according to an exemplary embodiment of the present invention;

FIG. 10 depicts a state of displaying a cell field according to an exemplary embodiment of the present invention;

FIG. 11 is a flowchart illustrating a moving process of a cell field according to an exemplary embodiment of the present invention;

FIG. 12 depicts setting of a coordinate where a selector can be placed according to an exemplary embodiment of the present invention;

FIG. 13 depicts a moving process of a cell field according to an exemplary embodiment of the present invention.

### DETAILED DESCRIPTION OF EXEMPLARY EMBODIMENTS

Aspects of the present invention and methods of accomplishing the same may be understood more readily by reference to the following detailed description of exemplary embodiments and the accompanying drawings. The aspects of the present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims.

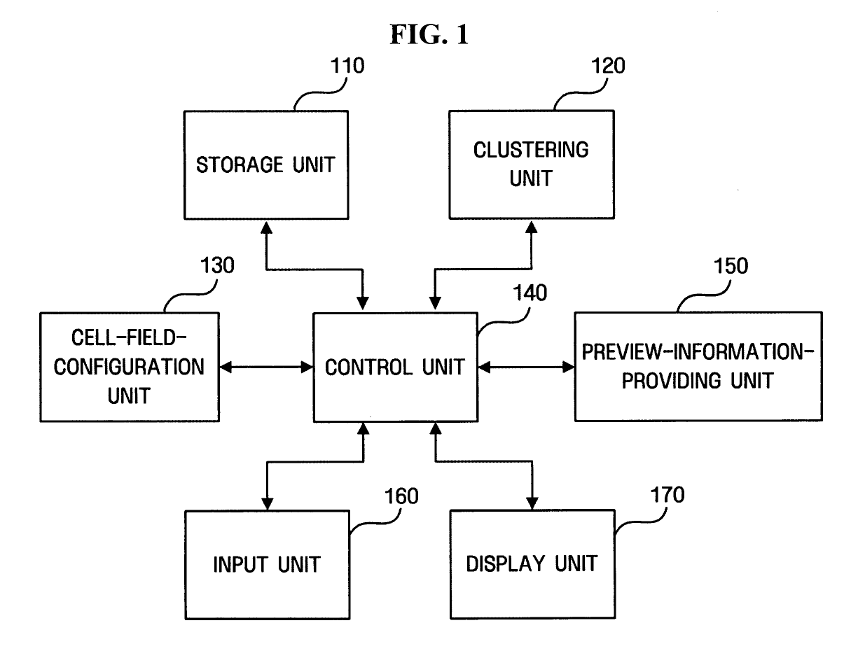

FIG. 1 is a block diagram illustrating a content-browsing apparatus according to an exemplary embodiment of the present invention. The illustrated content browsing apparatus includes a storage unit 110, a clustering unit 120, a cell field configuration unit 130, a control unit 140, a preview information providing unit 150, an input unit 160, and a display unit 170.

The storage unit 110 stores multimedia content such as images, moving pictures, and audio.

The clustering unit 120 clusters content stored in the storage unit 110. The clustering unit 120 extracts information corresponding to a predetermined clustering condition of content metadata, and clusters content based on the extracted information. A user can select one set of candidate information that was set in advance in order to decide the clustering condition.

Additional data, i.e., a title, a description, a date, a file size, and so on, which is referred to as “metadata”, may be added to the content. Examples of a field including additional data of content are the Identifier 3 (ID3) tag added to an MP3 file, Exif information added to a Joint Photographic Experts Group (JPEG) image, and the MPEG header added to MPEG-2 files. If a date when content is generated is set as the clustering condition, the clustering unit 120 extracts a date from metadata stored in the storage unit 110, and clusters content based on the extracted date.

Metadata included in the ID3 tag, the Exif information, and the MPEG header is additional data that is added to the content. According to an exemplary embodiment of the present invention, however, metadata also contains content information. The content information is not added to the content, but may be obtained through an analysis of the content. Examples of the content information are a timbre, a melody, a rhythm, and a tempo for audio content, and a color, a texture, and a face for image content.

If a color is set as the clustering condition for clustering image content, the clustering unit 120 extracts features such as a color histogram, which is the color atmosphere of the image, a dominant color that composes an image, and a color layout which is a color distribution of the image, and may cluster content by image content having a similar feature through an analysis of the image content.

According to a clustering result of the clustering unit 120, content may be divided into predetermined content groups. The clustering unit 120 may allocate a predetermined sequence number to each content group and content. If the clustering condition is the date when content is generated, the sequence number may be allocated to content groups and content in date order. As another example, if the clustering condition is a genre of content, sequence numbers may be allocated to content groups in alphabetical order of its genre, and to content in each content group in alphabetical order of its title. There are several sequence-number-allocating methods.

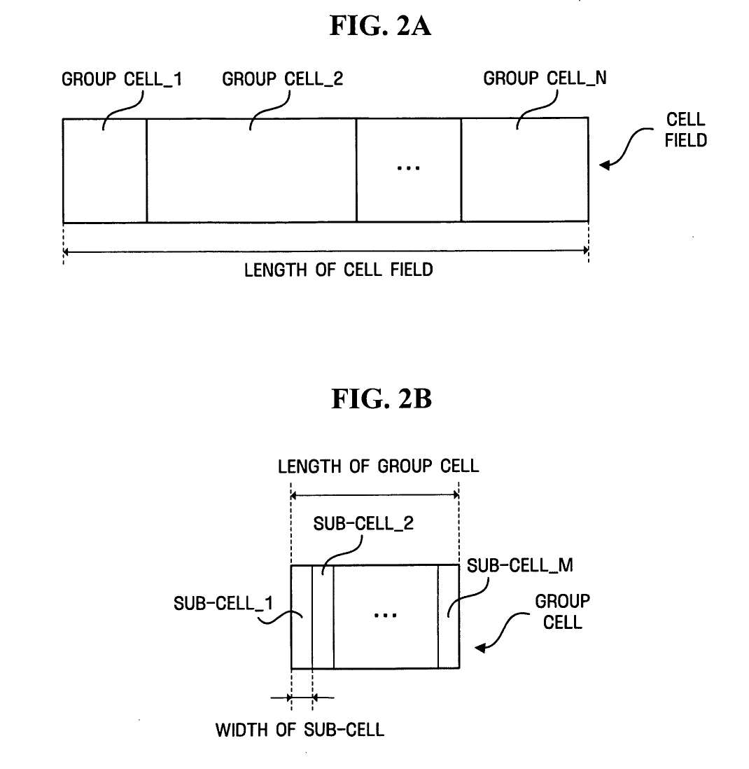

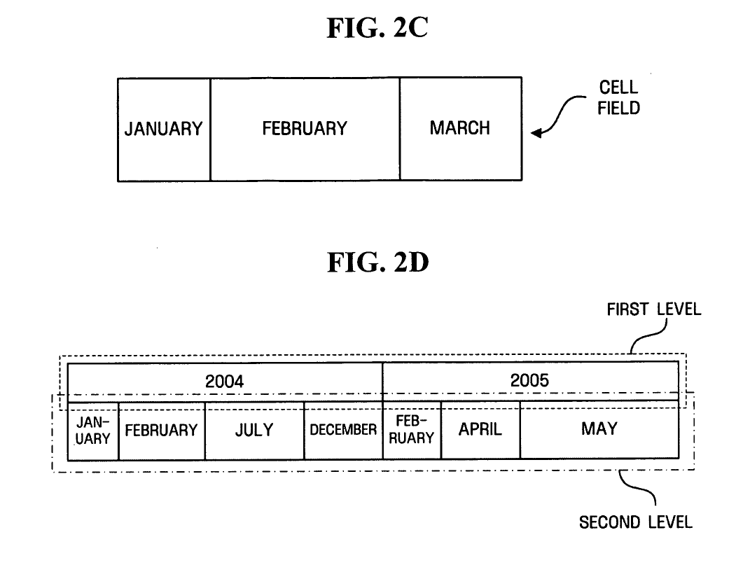

The cell field configuration unit 130 generates a cell field consisting of group cells. The group cells respectively correspond to content groups divided by the clustering 120. If N content groups exist, the number of group cells is N. Preferably, but not necessarily, the group cells are arranged in a series as illustrated in FIG. 2A. Arranging order of the group cells may be determined according to a sequence number allocated to each content group by the clustering unit 120.

Each group cell has subcells corresponding to content included in a corresponding content group. Accordingly, if M sets of content are in a specific content group, the number of subcells included in the group cell corresponding to the content group is also M. It may be desirable that the subcells are arranged in series as illustrated in FIG. 2B. Arranging order of the subcells may be determined according to the sequence number allocated to each content by the clustering unit 120. A boundary between subcells is visually depicted in FIG. 2B, which is exemplary. Accordingly, a boundary between subcells in a group cell may not be displayed as illustrated in FIG. 2A when a cell field is displayed by the display unit 170.

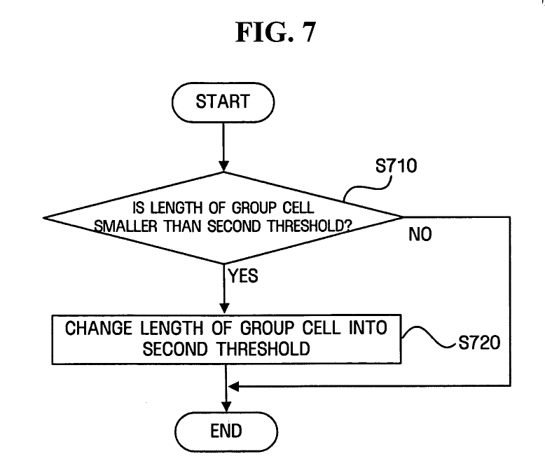

When the cell field is generated, the cell field configuration unit 130 may set a length of each group cell and a width of a subcell by group cells, which will be described with reference to FIGS. 6 and 7.

The cell field configuration unit 130 may generate titles of group cells. The titles of group cells are information on features of each content group in a clustering result according to the clustering condition. If the month of generating content is set as the clustering condition, when content groups are formed into content generated in January, February, and March, titles of group cells corresponding to each content group may be set as “January”, “February”, and “March”. The titles of group cells may be displayed on the group cell as illustrated in FIG. 2C, but the present invention is not limited thereto. The titles of group cells may be displayed corresponding to each group cell using various methods.

The cell field configuration unit 130 may compose a multi-level cell field according to an exemplary embodiment of the present invention as shown in FIG. 2D. If the year/month when content was generated is set as a clustering condition, the cell field configuration unit 130 may provide a dual level cell field that has a first level displaying the year and a second level displaying the month.

The control unit 140 controls an operation of the content browsing apparatus. Especially, the control unit 140 provides a selector that indicates one of subcells included in the cell field, and controls a movement of the selector. The control unit 140 may control a displaying position of a cell field generated by the cell field configuration unit 130, and preview information provided by the preview information providing unit 150 on a predetermined display area.

The preview information providing unit 150 provides preview information of content corresponding to the subcell indicated by the selector. The preview information includes some or all of the metadata. The type of metadata information to be used as preview information may be set in advance. If the content is an image, the preview-information-providing unit 150 may provide a thumbnail or the image.

The input unit 160 receives a predetermined control request by a user. The input unit 160 may include an input means such as a keypad, a touch pad, or a touch screen. The input unit 160 may receive and process a control signal of a remote controller. In this case, a user may input a desired control request via the remote controller.

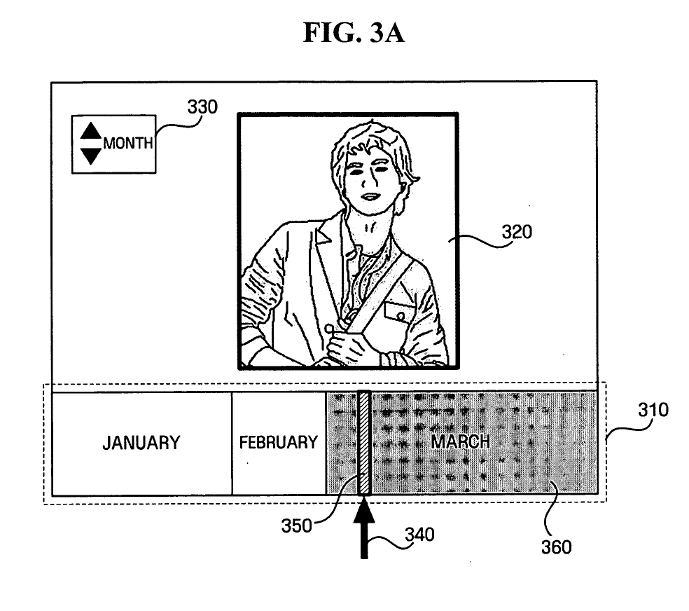

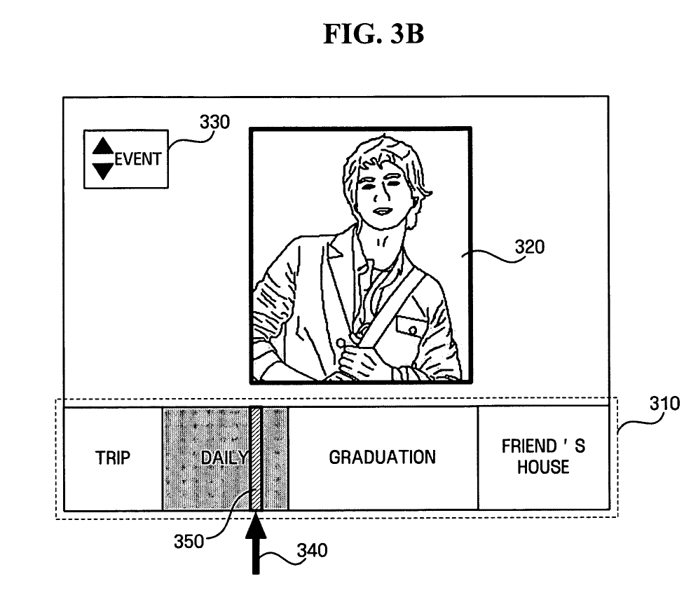

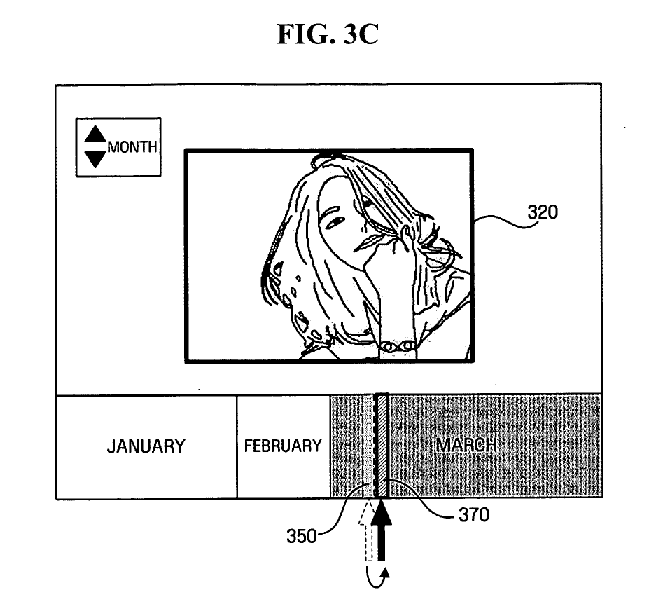

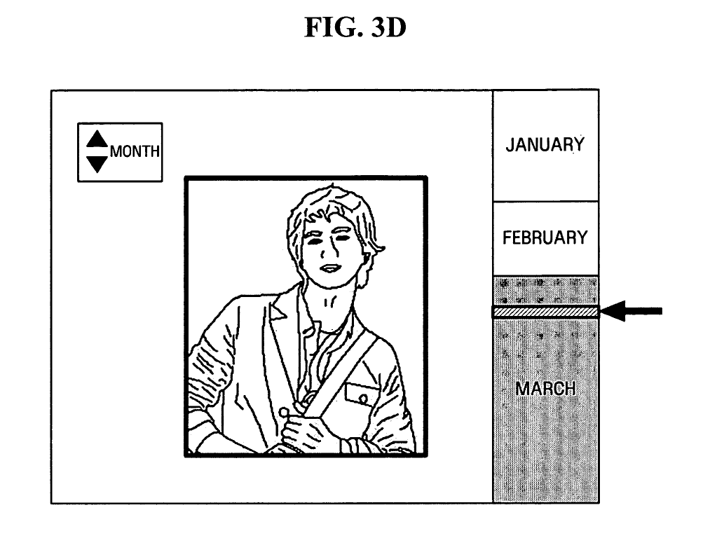

The display unit 170 displays a user interface for browsing content. The display unit 170 may include liquid crystal display (LCD), plasma display panel (PDP), and organic electroluminescence. FIG. 3A depicts an example of the user interface displayed by the display unit 170.

The user interface includes a first display area 310 where the cell field is displayed and a second display area 320 where the preview information of content is displayed. The user interface further includes a third display area 330 where a clustering condition is displayed, and a selector 340 that indicates a specific subcell. The second display area 320 displays a thumbnail of content corresponding to a subcell 350 indicated by the selector 340.

The control unit 140 enables a user to easily identify the subcell 350 indicated by the selector 340 through a color change, a highlight, an icon attachment, or a size change. The control unit 140 also enables a user to easily identify the group cell 360 including the subcell 350 through a color change, a highlight, an icon attachment, or a size change.

A user may change the clustering condition by handling a direction button or a function button included in the input unit 160 or the remote controller. FIG. 3B illustrates a user interface that is newly displayed if the clustering condition is changed when the user interface illustrated in FIG. 3A is displayed. The third display area 330 of the user interface illustrated in FIG. 3B shows that the clustering condition is changed into a “EVENT”. If the clustering condition is changed, the clustering unit 120 newly clusters content based on the new clustering condition. The cell field configuration unit 130 generates a cell field that has a group of cells corresponding to the newly formed content groups as a clustering result. The first display area 310 of the user interface illustrated in FIG. 3B shows that the newly formed cell field is displayed.

A user may also move the selector by handling a direction button or a function button included in the input unit 160 or the remote controller. If a user presses a right direction button of the remote controller when the user interface illustrated in FIG. 3A is displayed, the input unit 160 interprets and transmits the user's control request to the control unit 140. The control unit 140 moves the selector 340 to a position of a subcell 370 adjacent to the right of the subcell 350 indicated by the selector 360. If the selector 360 indicates the new subcell 370, the preview-information-providing unit 150 provides preview information of the content corresponding to the subcell 370. Accordingly, the second display area 320 displays new preview information as illustrated in FIG. 3C.

The cell field is horizontally displayed in the user interface in FIGS. 3A through 3C, but the present invention is not limited thereto. For example, the cell field may be vertically displayed in the user interface as illustrated in FIG. 3D.

In the exemplary embodiments of the present invention described above, a “unit” indicates a software component or a hardware component such as a Field Programmable Gate Array (FPGA) or an Application Specific Integrated Circuit (ASIC), which performs certain tasks. A unit may advantageously be configured to reside in the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and units, or further separated into additional components and modules. In addition, components and units may be implemented so as to reproduce one or more CPUs within a device or a secure multimedia card.

Hereinafter, an operation of the content-browsing apparatus will be described with reference to FIG. 1.

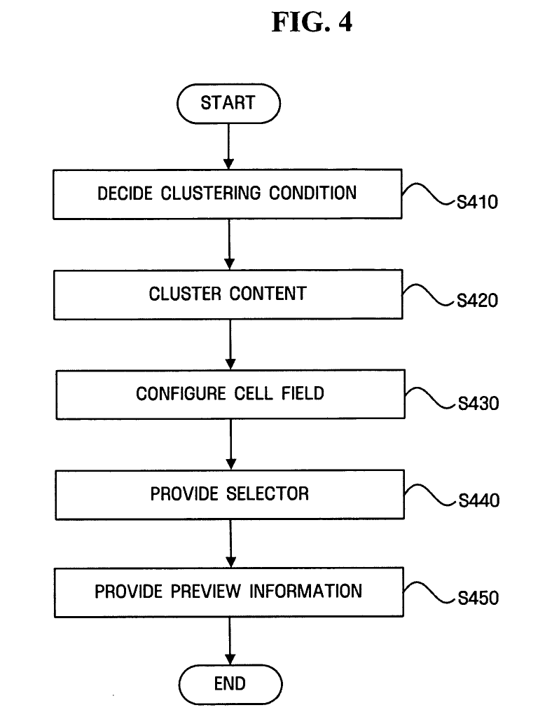

FIG. 4 is a flowchart illustrating a method of providing a user interface according to an exemplary embodiment of the present invention.

When a clustering condition is set by a user (S410), the clustering unit 120 clusters the content stored in the storage unit 110 according to the clustering condition (S420). Accordingly, content groups that have the same or similar features are formed according to the clustering result.

The cell field configuration unit 130 composes a cell field according to the clustering result (S430). As described with reference to FIGS. 2A through 2D, the cell field has group cells corresponding to the content groups, and each group cell includes subcells corresponding to content included in a respective content group.

A length of a group cell is decided through a total length of subcells included in the group cell as illustrated in FIG. 2B. That is, the length of the group cell is proportional to the number of subcells included in each group cell. The cell field configuration unit 130 may calculate a length of each group cell as illustrated in Equation 1:
Lᵢ=wᵢₙᵢₜᵢₐₗ×Mᵢ (1)

In Equation 1, Li is a length of an i-th group cell, Wᵢₙᵢₜᵢₐₗ is a initial value of a subcell width, and Mi is the number of subcells included in the i-th group cell. The variable Wᵢₙᵢₜᵢₐₗ may be set in advance considering the length of an area where the cell field will be displayed.

The control unit 140 provides a selector indicating a subcell (S440). The preview-information-providing unit 150 provides preview information of the content corresponding to the subcell indicated by the selector (S450). FIGS. 3A thorough 3D depicts the selector as an arrow icon, but the present invention is not limited thereto. The selector provided by the control unit 140 may be embodied as various icons, figures, colors, or the highlight.

The display unit 170 displays a user interface, which arranges the cell field generated by the cell field configuration unit 130, the selector provided by the control unit 140, and preview information provided by the preview-information-providing unit 150 on a predetermined display area, according to a control of the control unit 140. The display unit 170 may display the clustering condition according to instructions from the control unit 140 as illustrated in FIG. 3A.

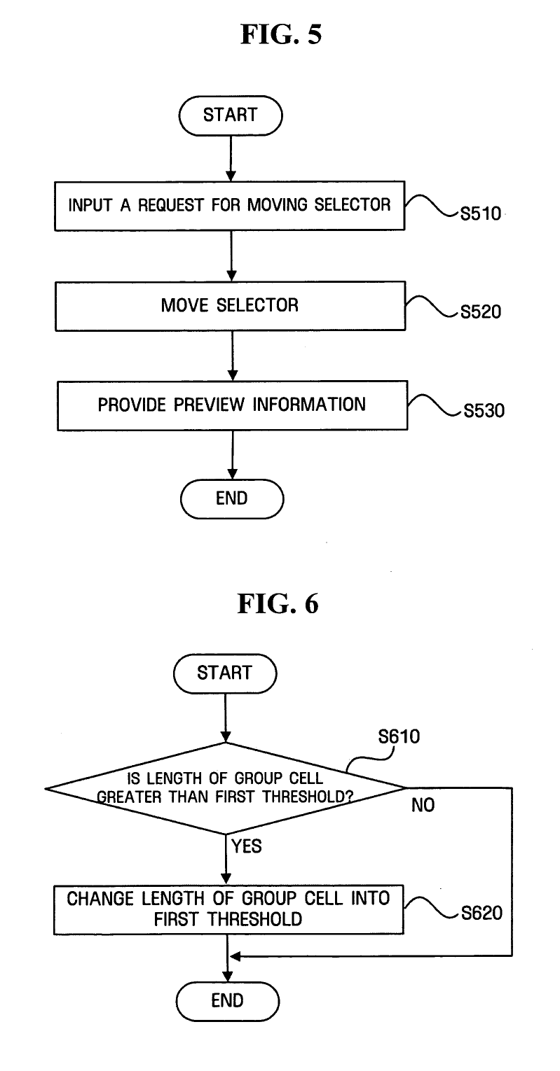

When the user interface is first displayed, the selector may indicate a first subcell or an arbitrary subcell. A user may request to move the selector via the input unit 160 or the remote controller, which will be described with reference to FIG. 5.

When a request for moving the selector is input via the input unit 160 (S510), the control unit 140 moves the selector to a position, corresponding to the request, on the user interface (S520). For example, a user can move the selector by controlling a left/right direction button of the remote controller in order to indicate a subcell located on a left/right of the subcell being indicated by the selector. Or a user can move the selector by handling an up/down direction button of the remote controller in order to indicate a subcell included in a next or previous group cell. Preferably, but not necessarily, the moving direction of the selector is a subcell-arranging direction, i.e., a horizontal direction of the length direction of the cell field.

When the selector moves, the preview-information-providing unit 150 searches for preview information of the content corresponding to the subcell newly indicated by the selector, and provides the found preview information (S530). For reference, the subcell indicated by the selector locates on a coordinate where the selector locates, or locates in certain range of the coordinate, in an axis of a subcell-arranging direction. The display unit 170 displays the movement of the selector and the newly provided information in the process of FIG. 5.

If the length of the group cell composed in S430 of FIG. 4 is greater or smaller than a threshold, the cell field configuration unit 130 may control the length, which will be described with reference to FIGS. 6 and 7.

FIG. 6 is a flow chart illustrating a process of controlling a length of a group cell and a width of a subcell according to an exemplary embodiment of the present invention.

If a length of each group cell is set in S430 of FIG. 4, the cell field configuration unit 130 determines whether the length of each group cell is longer than a first threshold (S610). The first threshold may be set in advance as the greatest length of a group cell.

If the length of the group cell is longer than the first threshold, the cell field configuration unit 130 changes the corresponding length into the first threshold (S620). In this case, the cell field configuration unit 130 may change the width of each subcell included in the corresponding group cell using Equation 2:

$${w}^{′} = \frac{{V}_{threshold 1}}{M} \qquad ( 2 )$$

In Equation 2, w′ is the changed width of each subcell, V_{threshold1} is the first threshold, and M is the number of the subcells included the changed group cell.

If a plurality of content are included in an arbitrary content group, the length of the group cell corresponding to the content group becomes significantly greater. This group cell may be an obstacle for a user to visually recognize another group cell. If a length of a specific group cell is greater than the length of the display area, when the group cell is displayed, it is difficult to check the existence of another group cell in a single screen; accordingly, which can be resolved by performing the process of FIG. 6.

If a few sets of content are included in an arbitrary content group because the length of the group cell corresponding to the content group is short, this group cell may be an obstacle to display a title of the group cell or for a user to visually determine the existence of the group cell. To prevent this problem, the cell field configuration unit 130 may enlarge the width of the group cell which is smaller than the threshold, which is illustrated in FIG. 7.

If a length of each group cell is set in S430 of FIG. 4, the cell field configuration unit 130 determines whether the length of each group cell is smaller than a second threshold (S710). In this case, the second threshold may be set in advance as the smallest length of the group cell.

If the length of the group cell is smaller than the second threshold, the cell field configuration unit 130 changes the corresponding length into the second threshold (S720). In this case, the cell field configuration unit 130 may change the width of each subcell included in the corresponding group cell using Equation 3.

$${w}^{′} = \frac{{V}_{threshold 2}}{M} \qquad ( 3 )$$

In Equation 3, w′ is the changed width of each subcell, V_{threshold2} is the second threshold, and M is the number of the subcells included the changed group cell.

The cell field configuration unit 130 may perform only one of two processes described with reference to FIGS. 6 and 7 for each group cell, or both processes for each group cell.

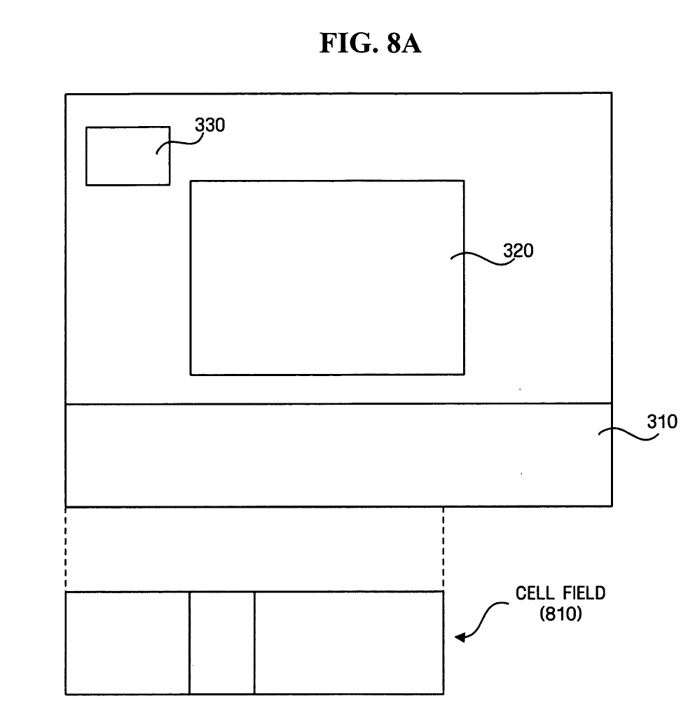

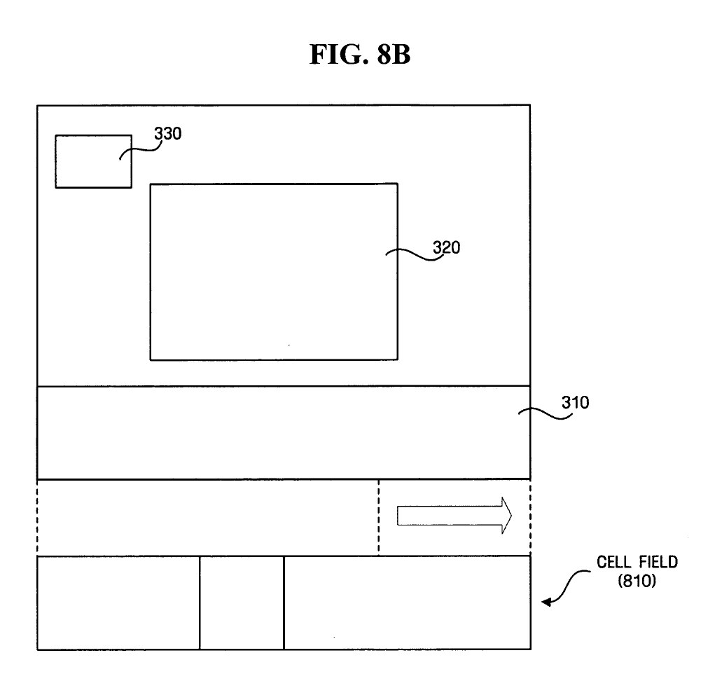

If a length of each group cell is set through S430 of FIG. 4 and processes of FIGS. 6 and 7, and a length of the cell field is determined. The length of the cell field is the total length of the group cell as illustrated in FIG. 2A. If the length of a cell field 810 is smaller than the length of a first display area 310 as illustrated in FIG. 8A, the cell field configuration unit 130 may fit the length of the cell field 810 to the length of the first display area 310 by enlarging the width of group cells as illustrated in FIG. 8B.

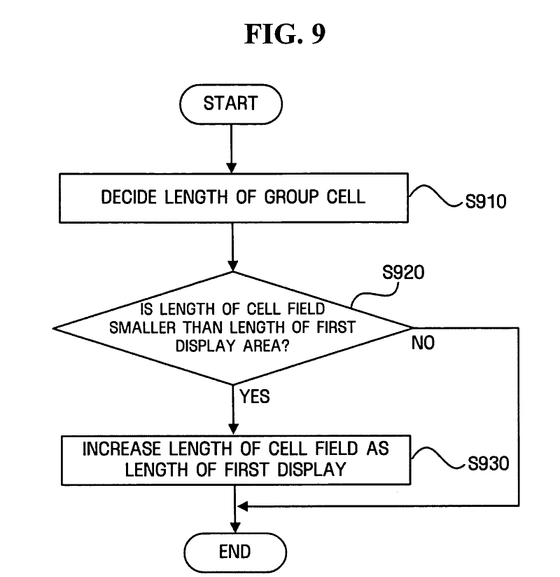

Referring to FIG. 9, when the length of the group cells is determined (S910), the cell field configuration unit 130 determines whether the total length of the group cells, i.e., the length of the cell field, is smaller than the length of the first display area (S920). The step S910 may mean that the cell field configuration unit 130 performs S430 of FIG. 4. However, if the cell field configuration unit 130 also performs processes of FIG. 6 or 7, S910 of FIG. 9 may mean that the processes of FIG. 6 or 7 are performed.

If the length of the cell field is smaller than the length of first display area, the cell field configuration unit 130 enlarges the length of the cell field to be as long as the length of the first display area (S930). Here, the length of the group cells and the width of the subcells may be enlarged at the same rate as the increasing portion of the length of the cell field; for this, the cell field configuration unit 130 may use Equations 4 and 5. Equation 4 is used to enlarge the length of the group cells, and Equation 5 is used to enlarge the width of the subcells.

$${L}_{i}^{′} = \frac{A}{L} \times {L}_{i} \qquad ( 4 )$$

In Equation 4, Lᵢ′ is the changed length of the i-th group cell, A is the length of the first display area, L is the length of the cell field, and Lᵢ is the length of the i-th group cell before the change.

$${w}_{i}^{′} = \frac{A}{L} \times {w}_{i} \qquad ( 5 )$$

In Equation 5, wᵢ′ is the changed length of a subcell included in the i-th group cell, A is the length of the first display area, L is the length of the cell field, and wᵢ is the length of the subcell included in the i-th group cell before the change.

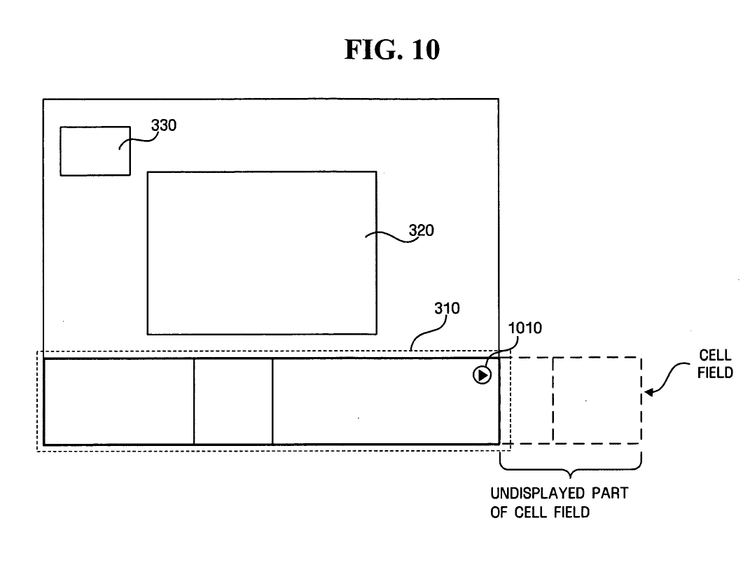

If the length of the cell field is greater than the length of the first display area, some group cells may be not displayed on the first display area 310 as illustrated in FIG. 10. In this case, the control unit 140 may provide information 1010 that remaining cell fields exist.

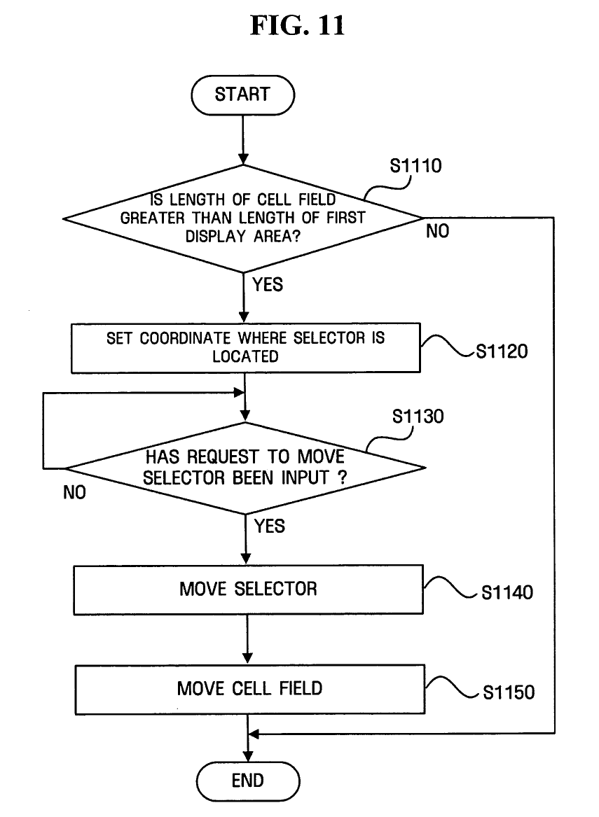

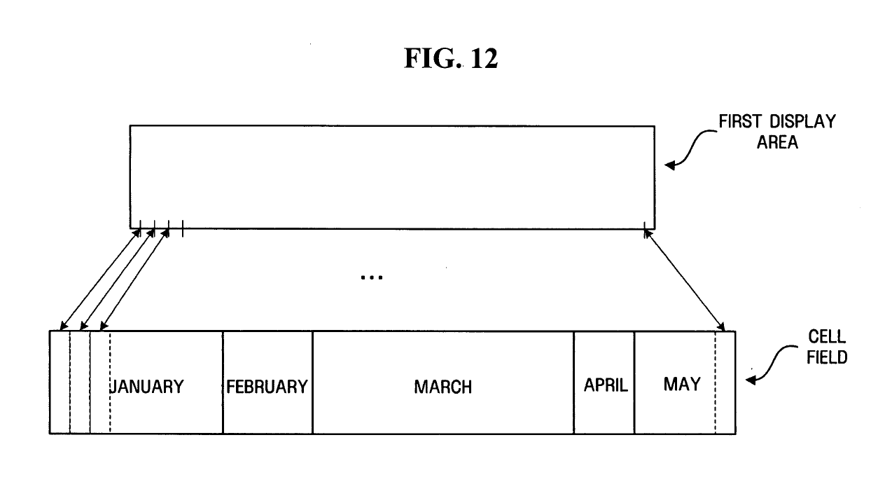

To check the remaining cell fields, the cell field has to move on the first display area 310. The control unit 140 may control a movement of the cell field regardless of a movement of the selector. That is, a user can request to move the selector and the cell field via the input unit 160 and the remote controller independently. According to an exemplary embodiment of the present invention, however, the control unit 160 may control the movement of the cell field according to the movement of the selector, which will be described with reference to FIG. 11.

The control unit 140 determines whether the length of the cell field composed by the cell field configuration unit 130 is greater than the length of the first display area (S1110). If the length of the cell field is greater than the length of the first display area, the control unit 140 sets the number of coordinates where the selector can be located in the length direction of the cell field as the number of subcells in the first display area (S1120).

According to an exemplary embodiment of the present invention, as a coordinate where the selector can be located, the coordinate where each subcell is located may be used when the cell field is reduced so that the length of the cell field is the same as the length of the first display area as illustrated in FIG. 12. In this case, each coordinate where the selector can be located corresponds to a respective subcell in the cell field in regular sequence.

When a request for moving the selector is input via the input unit 160 (S1130), the control unit 140 moves the selector to a position corresponding to the request (S1140), moving the cell field in the first display area in order for the subcell, corresponding to the coordinate where the selector is located, to be located on the corresponding coordinate (S1150).

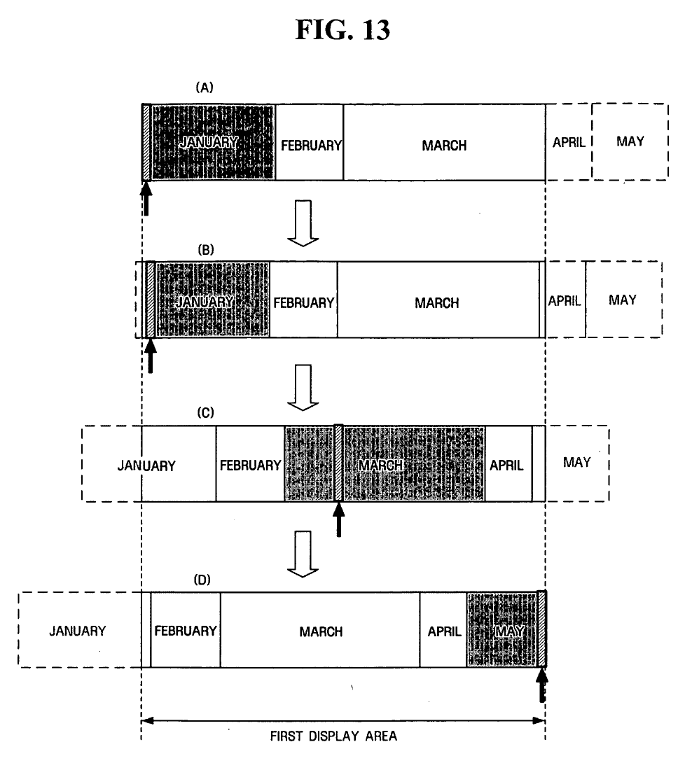

FIG. 13 depicts a process of moving the cell field, and illustrates only the first display area of the user interface. Parts not displayed on the first display area are illustrated as a dotted line in FIG. 13.

The (A) of FIG. 13 shows that the selector indicates a first subcell of the cell field. Here, the selector and the first subcell are located on a first coordinate of coordinates set in the first display area.

If a user moves the selector to the right, the control unit 140 moves the selector to a second coordinate in the first display area, moving the cell field in a left direction in order for a second subcell of the cell field to be located on a coordinate where the selector is also located. In this case, the cell field displayed on the first display area is the same as the (B) of FIG. 13.

The control unit 140 can move the selector and the cell field in a direction opposite to each other. The (C) and (D) of FIG. 13 depicts the cell field displayed on the first display area when the selector is moved to the right.

In the foregoing description, the user-interface for browsing content, the user interface providing a method for the same, and the content-browsing apparatus according to the present invention are applied to easily perform a search for content.

While the present invention has been particularly shown and described with reference to the exemplary embodiments thereof, it will be understood by those of ordinary skill in the art that various changes may be made in the form and details without departing from the spirit and scope of the present invention as defined by the following claims. Therefore, it is to be understood that the above-described embodiments have been provided only in a descriptive sense and will not be construed as placing any limitation on the scope of the invention.

What is claimed is:

1. A user interface for browsing content, the user interface comprising:
a cell field that comprises a group cell comprising a subcell corresponding to content included in a content group determined by a clustering condition, the group cell corresponding to the content group;
a selector that indicates the subcell; and
preview information for the content corresponding to the subcell indicated by the selector.

2. The user interface of claim 1, wherein the user interface further comprises a title corresponding to the group cell.

3. The user interface of claim 1, wherein the cell field comprises a plurality of levels according to the clustering condition.

4. The user interface of claim 1, wherein the group cell comprises a plurality of subcells which are serially arranged, and the cell field comprises a plurality of group cells which are serially arranged.

5. The user interface of claim 4, wherein the selector moves between the plurality of the subcells on an axis of the plurality of the subcells.

6. The user interface of claim 1, wherein if a length of the cell field is greater than a length of a display area which displays the user interface, the selector moves between coordinates which are set such that a number of the coordinates is the same as a number of subcells, which is included in the cell field, in a length direction of the cell field, and the cell field moves in order for a subcell, corresponding to a coordinate where the selector is located, to be located on the coordinate.

7. The user interface of claim 6, wherein if the length of the cell field is reduced so that the length of the cell field is the same as the length of the display area, the coordinate is a position where the subcell, corresponding to the coordinate where the selector is located, is located in the display area.

8. A user interface providing method comprising:
dividing a plurality of content into a number of content groups according to a clustering condition; and
providing a user interface which comprises:
a cell field comprising a group cell comprising a subcell corresponding to content included in a content group determined by the clustering condition, the group cell corresponding to the content group;
a selector that indicates the subcell; and
preview information for the content corresponding to the subcell indicated by the selector.

9. The method of claim 8, wherein the user interface further comprises a title corresponding to the group cell.

10. The method of claim 8, wherein the user interface further comprises the clustering condition.

11. The method of claim 8, wherein the cell field comprises a plurality of levels according to the clustering condition.

12. The method of claim 8, wherein the group cell comprises a plurality of subcells which are serially arranged, and the cell field comprises a plurality of group cells which are serially arranged.

13. The method of claim 12, further comprising allocating a sequence number to each of the divided content groups and each of the plurality of the content, wherein arranging order of the plurality of the group cells is determined according to the sequence number allocated to each of the content groups corresponding to the plurality of the group cells, and arranging order of the plurality of the subcells is determined according to the sequence number allocated to each of the plurality of the content corresponding to the plurality of the subcells.

14. The method of claim 12, if a request for moving the selector is input, the method further comprising:
moving the selector in a direction that the plurality of the subcells are arranged; and
providing preview information for content corresponding to a new subcell indicated by the moved selector.

15. The method of claim 12, further comprising generating the cell field, wherein a length of the cell field is a total length of the plurality of the group cells included in the cell field, and a length of each of the plurality of the group cells is a total width of subcells included in each of the plurality of the group cells.

16. The method of claim 15, wherein a width of the subcell has an initial value set in advance.

17. The method of claim 15, wherein if a length of the group cell is greater than a first threshold, the generating of the cell field comprises changing the length of the group cell into the first threshold, and reducing a width of the subcell included in the group cell at the same rate as a changing portion of the length of the group cell.

18. The method of claim 15, wherein if a length of the group cell is smaller than a second threshold, the generating the cell field comprises changing the length of the group cell into the second threshold, and increasing a width of the subcell included in the group cell at the same rate as a changing portion of the length of the group cell.

19. The method of claim 15, wherein if a length of the cell field is smaller than a length of a display area, the generating the cell field comprises increasing the length of the cell field in order to correspond to the length of the display area, and increasing a length of the group cell and a width of the subcell at the same rate as an increasing portion of the length of the cell field.

20. The method of claim 15, wherein if a length of the cell field is greater than a length of a display area, the generating the cell field comprises setting coordinates in the display area such that a number of the coordinates is the same as a number of subcells included in the cell field in a length direction of the cell field, and, if a request for moving the selector is input, moving the selector to a coordinate corresponding to the request and moving the cell field in order for a subcell, corresponding to a coordinate where the selector is located, to be located on the coordinate.

21. The method of claim 20, wherein if the length of the cell field is reduced so that the length of the cell field is the same as the length of the display area, the generating the cell field further comprises setting a position of the subcell, corresponding to the coordinate where the selector is located, as the coordinate.

22. A content-browsing apparatus comprising:
a clustering unit that divides a plurality of content into a number of content groups according to a clustering condition; and
a display unit that displays a user interface which comprises:
a cell field comprising a group cell comprising a subcell corresponding to content included in a content group determined by the clustering condition, the group cell corresponding to the content group;
a selector that indicated the subcell; and
preview information for the content corresponding to the subcell indicated by the selector.

23. The apparatus of claim 22, wherein the user interface further comprises a title corresponding to the group cell.

24. The apparatus of claim 22, wherein the user interface further comprises the clustering condition.

25. The apparatus of claim 22, wherein the cell field comprises a plurality of levels according to the clustering condition.

26. The apparatus of claim 22, wherein the group cell comprises a plurality of subcells which are serially arranged, and the cell field comprises a plurality of group cells which are serially arranged.

27. The apparatus of claim 26,
wherein the clustering unit allocates a sequence number to each of the divided content groups and each of the plurality of the content; and
wherein arranging order of the plurality of the group cells is determined according to the sequence number allocated to each of the content groups corresponding to the plurality of the group cells, and arranging order of the plurality of the subcells is determined according to the sequence number allocated to each of the plurality of the content corresponding to the plurality of the subcells.

28. The apparatus of claim 26, wherein if a request for moving the selector is input, the apparatus further comprises:
a control unit that moves the selector in a direction that the plurality of the subcells are arranged if a request for moving the selector is input; and
a preview information providing unit that provides preview information for content corresponding to a new subcell indicated by the moved selector.

29. The apparatus of claim 26, further comprising a cell field configuration unit that generates the cell field, wherein a length of the cell field is a total length of the plurality of the group cells included in the cell field, and a length of each of the plurality of the group cells is a total width of subcells included in each of the plurality of the group cells.

30. The apparatus of claim 29, wherein a width of the subcell has an initial value set in advance.

31. The apparatus of claim 29, wherein if a length of the group cell is greater than a first threshold, the cell field configuration unit changes the length of the group cell into the first threshold, and reduces a width of the subcell included in the group cell at the same rate as a changing portion of the length of the group cell.

32. The apparatus of claim 29, wherein if a length of the group cell is smaller than a second threshold, the cell field configuration unit changes the length of the group cell into the second threshold, and increases the width of the subcell included in the group cell at the same rate as a changing portion of the length of the group cell.

33. The method of claim 29, wherein if a length of the cell field is smaller than a length of a display area, the cell field configuration unit increases the length of the cell field in order to correspond to the length of the display area, and increases a length of the group cell and a width of the subcell at the same rate as an increasing portion of the length of the cell field.

34. The apparatus of claim 29, wherein if a length of the cell field is greater than a length of a display area, the apparatus further comprises a control unit that sets coordinates in the display area such that a number of the coordinates is the same as a number of subcells included in the cell field in the length direction of the cell field, and, if a request for moving the selector is input, moves the selector to a coordinate corresponding to the request and moves the cell field in order for a subcell, corresponding to a coordinate where the selector is located, to be located on the coordinate.

35. The apparatus of claim 34, wherein if the length of the cell field is reduced so that the length of the cell filed is the same as the length of the display area, the control unit sets a position of the subcell, corresponding to the coordinate where the selector is located, as the coordinate.
